(19) United States
(12) Patent Application Publication
(10) Pub. No.: US 2017/0111911 A1
(43) Pub. Date: Apr. 20, 2017

(54) USER APPARATUS, BASE STATION, UPLINK DATA DIVIDING RATIO CALCULATION METHOD, AND UPLINK DATA DIVIDING RATIO PROVIDING METHOD

(71) Applicant: NTT DOCOMO, INC., Tokyo (JP)

(72) Inventors: Tooru Uchino, Tokyo (JP); Hideaki Takahashi, Tokyo (JP); Liu Liu, Beijing (CN); Huiling Jiang, Beijing (CN)

(73) Assignee: NTT DOCOMO, INC., Tokyo (JP)

(21) Appl. No.: 15/129,446

(22) PCT Filed: Apr. 14, 2015
(86) PCT No.: PCT/JP2015/061463

§ 371 Date: Sep. 27, 2016

(30) Foreign Application Priority Data
Apr. 18, 2014 (JP) 2014-086728

(51) Int. Cl. H04W 72/04; H04W 24/02; H04W 28/08; H04W 28/16; H04W 72/08

(52) U.S. Cl. CPC H04W 72/0453; H04W 28/16; H04W 72/08; H04W 28/08; H04W 24/02; H04W 88/08

(57) ABSTRACT

A user apparatus in a mobile communication system including a first base station and a second base station which perform communications with the user apparatus by inter-base-station carrier aggregation, includes a radio-quality obtaining unit for obtaining first radio-quality between the user apparatus and the first base station, second radio-quality between the user apparatus and the second base station; a load-information obtaining unit for obtaining first load-information in the first base station and second load-information in the second base station; and a ratio calculation unit for calculating a dividing ratio used by the user apparatus for dividing uplink data and transmitting the divided data to the first base station and the second base station by using the first radio-quality and the second radio-quality obtained by the radio quality obtaining unit and the first load-information and the second load-information obtained by the load-information obtaining unit.

### BACKGROUND OF THE INVENTION

1. Field of the Invention

The present invention relates to a technology in which a user apparatus transmits data to a plurality of base stations in a mobile communication system.

2. Description of the Related Art

In an LTE system, carrier aggregation (hereinafter, referred to as CA) has been introduced. CA enables communications by using a plurality of component carriers (hereinafter, referred to as CC) at the same time. As illustrated in FIG. 1, in CA up to LTE Rel-10, it is possible to realize high throughput by performing simultaneous communications by using multiple CCs under the same base station eNB.

On the other hand, in LTE Rel-12, the above operation is further enhanced and dual connectivity (DC) is proposed in which simultaneous communications are performed to realize high throughput by using CCs under different base stations eNB (Non Patent Document 1). In other words, in dual connectivity (DC), a user apparatus UE performs communications by simultaneously using radio resources of two physically different base stations eNB.

Dual connectivity is also referred to as Inter eNB CA (inter-base-station carrier aggregation), and a Master-eNB (MeNB) and a Secondary-eNB (SeNB) are introduced. An example of dual connectivity is illustrated in FIG. 2. In an example of FIG. 2, a MeNB communicates with the user apparatus UE via CC#1, a SeNB communicates with the user apparatus UE via CC#2, and thus, dual connectivity is realized.

In dual connectivity, (one or multiple) cells under the MeNB are referred to as a master cell group (MCG), and (one or multiple) cells under the SeNB are referred to as a secondary cell group (SCG).

### CITATION LIST

### Non-Patent Document

[Non-Patent Document 1] 3GPP TR 36.842 V12.0.0 (2013-12)

### SUMMARY OF THE INVENTION

### Technical Problem

In dual connectivity illustrated in FIG. 2, a technique of an uplink bearer split (UL bearer split) has been discussed in which the user apparatus UE transmits a bearer data item (which may be referred to as a packet) to multiple base stations. It should be noted that the bearer is a logical communication path of a packet.

An example of an uplink bearer split in dual connectivity illustrated in FIG. 2 is illustrated in FIG. 3. In an example of FIG. 3, the user apparatus UE transmits a part of (a specific ratio of) the bearer data to a base station MeNB via CC#1 and transmits the remaining bearer data to a base station SeNB via CC#2. Further, in an example of FIG. 3, the base station SeNB transmits the data received via CC#2 to the base station MeNB, and the base station MeNB transfers the data to a core network 10.

Radio interface protocols in LTE include PHY (Physical), MAC (Media Access Control), RLC (Radio Link Control), and PDCP (Packet Data Convergence Protocol). The user apparatus UE includes corresponding entities (functional units which process corresponding protocols). In UL bearer split, as illustrated in FIG. 4, bearer data (PDCP PDU) is divided at a PDCP entity, one divided data item is transmitted to a RLC/MAC entity which performs a process of transmission to the base station MeNB, and another divided data item is transmitted to another RLC/MAC entity which performs a process of transmission to the base station SeNB. In the following, it is assumed that in the case where a symbol “1” is added, the value is for the base station MeNB, and in the case where a symbol “2” is added, the value is for the base station SeNB.

Here, it is assumed, for example, that data amount of PDCP data for UL transmission is X, data amount of RLC data for UL transmission to the base station MeNB is Y1, and data amount of RLC data for UL transmission to the base station SeNB is Y2. Further, it is assumed that division ratio of the PDCP data (hereinafter, referred to as ratio) is α. The ratio α is a ratio of the data amount transmitted to the base station MeNB relative to the combined data amount transmitted to the base station MeNB and the base station SeNB. The above description will be also applied to the description below. It should be noted that the above definition of the ratio is merely an example.

In this case, the amount of data to be transmitted to the base MeNB (buffer size) is αX+Y1, and the amount of data to be transmitted to the base station SeNB (buffer size) is (1−α)X+Y2.

As described above, by setting the ratio α, it is possible to divide the data between the base station MeNB and the base station SeNB according to the ratio α. However, there is no related art for appropriately calculating and setting the ratio. As a result, there is a possibility that the user apparatus UE cannot report appropriately divided UL data remaining amounts to the base stations. In such a case, allocation resource shortage or excessive resource allocation may occur, and a degradation of UL throughput or a decline of resource usage efficiency may occur.

In view of the above, an object of the present invention is to provide a technique in which it is possible for the user apparatus to appropriately calculate the dividing ratio which is used when the user apparatus divides uplink data and transmits the divided data to a first base station and a second base station.

### Solution to Problem

According to an embodiment, a user apparatus in a mobile communication system including a first base station and a second base station which base stations communicate with the user apparatus by inter-base-station carrier aggregation is provided. The user apparatus includes a radio quality obtaining unit configured to obtain first radio quality between the user apparatus and the first base station and second radio quality between the user apparatus and the second base station; a load information obtaining unit configured to obtain first load information in the first base station and second load information in the second base station; and a ratio calculation unit configured to calculate, by using the first radio quality and the second radio quality obtained by the radio quality obtaining unit and the first load information and the second load information obtained by the load information obtaining unit, a dividing ratio used by the user apparatus for dividing uplink data and transmitting the divided data to the first base station and the second base station.

Further, according to an embodiment, a user apparatus in a mobile communication system including a first base station and a second base station which base stations communicate with the user apparatus by inter-base-station carrier aggregation is provided. The user apparatus includes a transmission rate obtaining unit configured to obtain a first transmission rate of data transmission from the user apparatus to the first base station and a second transmission rate of data transmission from the user apparatus to the second base station; and a ratio calculation unit configured to calculate, by using the first transmission rate and the second transmission rate obtained by the transmission rate obtaining unit, a dividing ratio used by the user apparatus for dividing uplink data and transmitting the divided data to the first base station and the second base station.

Further, according to an embodiment, a base station corresponding to a first base station in a mobile communication system including the first base station and a second base station which base stations communicate with a user apparatus by inter-base-station carrier aggregation is provided. The base station includes a radio quality obtaining unit configured to obtain first radio quality between the user apparatus and the first base station and second radio quality between the user apparatus and the second base station; a load information obtaining unit configured to obtain first load information in the first base station and second load information in the second base station; a ratio calculation unit configured to calculate, by using the first radio quality and the second radio quality obtained by the radio quality obtaining unit and the first load information and the second load information obtained by the load information obtaining unit, a dividing ratio used by the user apparatus for dividing uplink data and transmitting the divided data to the first base station and the second base station; and a transmission unit configured to transmit the dividing ratio calculated by the ratio calculating unit to the user apparatus.

Further, according to an embodiment, a base station corresponding to a first base station in a mobile communication system including the first base station and a second base station which base stations communicate with a user apparatus by inter-base-station carrier aggregation is provided. The base station includes a transmission rate obtaining unit configured to obtain a first transmission rate of data transmission from the user apparatus to the first base station and a second transmission rate of data transmission from the user apparatus to the second base station; a ratio calculation unit configured to calculate, by using the first transmission rate and the second transmission rate obtained by the transmission rate obtaining unit, a dividing ratio used by the user apparatus for dividing uplink data and transmitting the divided data to the first base station and the second base station; and a transmission unit configured to transmit the dividing ratio calculated by the ratio calculating unit to the user apparatus.

### Advantageous Effects of Invention

According to an embodiment, it is possible for the user apparatus to appropriately calculate the division ratio which is used when the user apparatus divides uplink data and transmits the divided data to a first base station and a second base station.

### BRIEF DESCRIPTION OF THE DRAWINGS

FIG. 1 is a drawing illustrating CA up to Rel-10.

FIG. 2 is a drawing illustrating an example of dual connectivity.

FIG. 3 is a drawing illustrating an example of bearer split in dual connectivity.

FIG. 4 is a drawing illustrating a problem.

FIG. 5 is a drawing illustrating a structure example of a communication system according to an embodiment of the present invention.

FIG. 6 is a drawing illustrating an overview of functions of a user apparatus UE according to a first embodiment.

FIG. 7 is a drawing illustrating an example 1-1 according to a first embodiment.

FIG. 8 is a drawing illustrating a prohibit timer operation when load information is transmitted from a base station to a user apparatus UE.

FIG. 9 is a drawing illustrating an example 1-2 according to a first embodiment.

FIG. 10 is a drawing illustrating an example of transition of a ratio α in an example 1-2.

FIG. 11 is a drawing illustrating an example 1-3 according to a first embodiment.

FIG. 12 is a drawing illustrating an example of transition of a ratio α in an example 1-3.

FIG. 13 is a drawing illustrating an example 2-1 according to a second embodiment.

FIG. 14 is a drawing illustrating an example 2-2 according to a second embodiment.

FIG. 15 is a drawing illustrating an example 2-3 according to a second embodiment.

FIG. 16 is a functional configuration diagram of the user apparatus UE.

FIG. 17 is a flowchart illustrating operations of the user apparatus UE.

FIG. 18 is a hardware configuration diagram of the base station MeNB.

FIG. 19 is a flowchart illustrating operations of the base station MeNB.

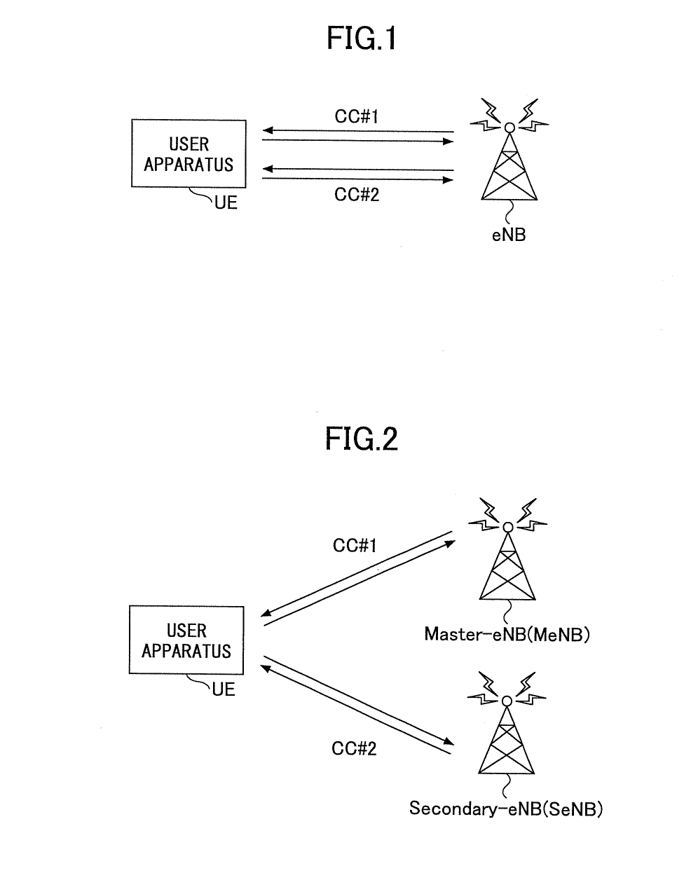

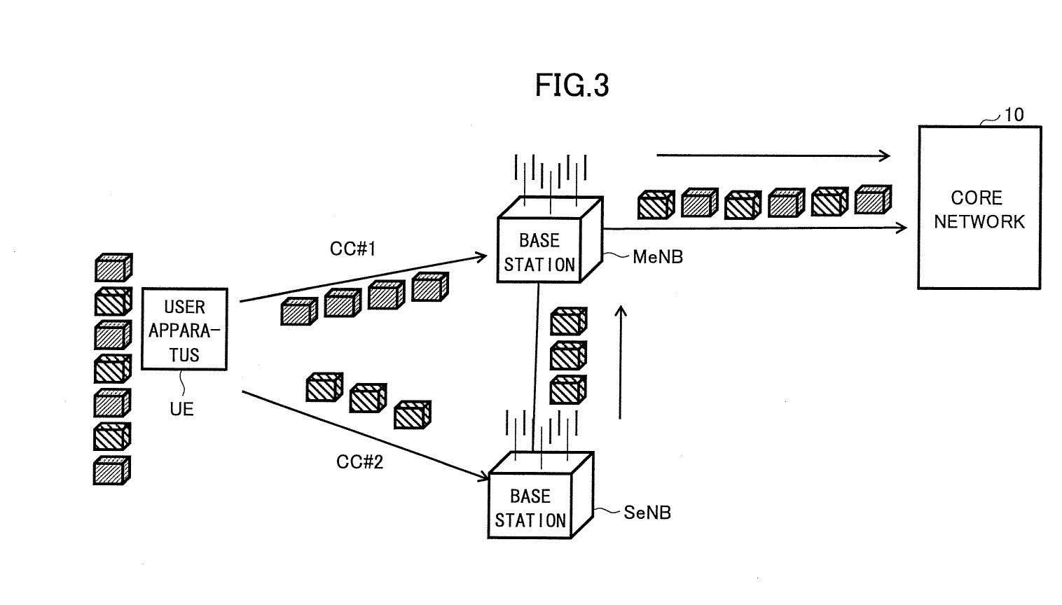

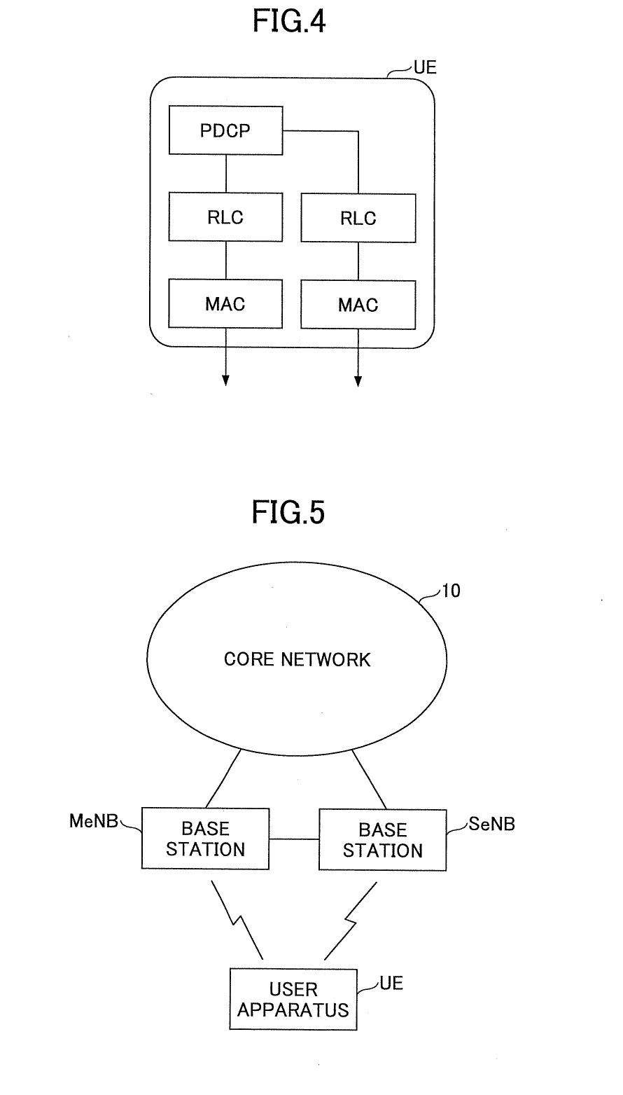

### DETAILED DESCRIPTION OF THE PREFERRED EMBODIMENTS

In the following, referring to the drawings, embodiments of the present invention will be described. It should be noted that the embodiments described below are merely examples and the embodiments to which the present invention is applied are not limited to the following embodiments. For example, it is assumed that a communication system according to an embodiment corresponds to LTE. However, the present invention can be applied, not limited to LTE, but can be also applied to other schemes. Further, in the present application specification and claims, unless otherwise specified, the term “LTE” is used as the meaning defined in 3GPP Rel-12, or later.

### Overall Configuration Example of Communication System

FIG. 5 illustrates a configuration example of a mobile communication system according to an embodiment (common to a first embodiment and a second embodiment). As illustrated in FIG. 5, the mobile communication system according to an embodiment includes a base station MeNB and a base station SeNB connected to a core network 10, respectively, and thus, dual connectivity is available between the user apparatus UE and the base stations MeNB and SeNB. Further, communications can be performed between the base station MeNB and the base station SeNB, for example, via X2 interface.

According to an embodiment, the user apparatus UE performs bearer split at the time of UL transmission, divides uplink data, and transmits the divided data to the base station MeNB and the base station SeNB. As described above, when performing bearer split, the user apparatus UE divides the data into data for the base station MeNB and data for the base station SeNB by using the ratio α. In the following, an example in which the user apparatus UE determines the ratio α will be described as a first embodiment, and an example in which the base station MeNB decides the ratio α and transmits the ratio α to the user apparatus UE will be described as a second embodiment.

### First Embodiment

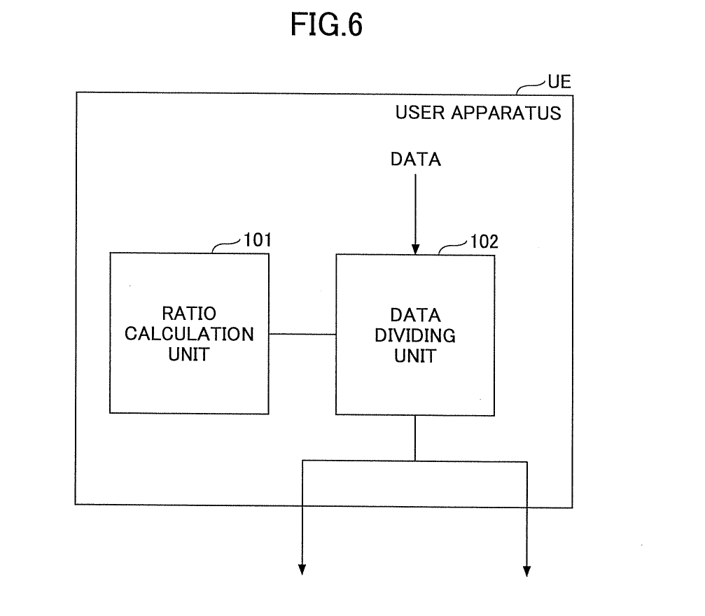

First, a first embodiment will be described. In the first embodiment, the user apparatus UE determines the ratio α according to a predetermined rule. Referring to FIG. 6, an overview of the first embodiment will be described. As illustrated in FIG. 6, the user apparatus UE includes a ratio calculation unit 101 as a function unit for calculating the ratio α, and a data dividing unit 102 as a function unit for dividing data of a single bearer (communication path) into two data items (for MeNB and for SeNB) according to the ratio α.

In the first embodiment, there are an example 1-1 in which the ratio α is determined based on radio quality and load information, an example 1-2 in which the ratio α is determined based on UL transmission rate, and an example 1-3 in which the example 1-1 and the example 1-2 are combined. In the following, each of the examples will be described. It should be noted that the example 1-1 can be referred to as an open loop method, and the example 1-2 can be referred to as a closed loop method.

As will be described below, in the examples according to an embodiment, a PDCP entity calculates the ratio α, which is merely an example. Calculation of the ratio α may be performed by a functional unit other than the PDCP entity in the user apparatus UE. Further, in the examples according to an embodiment, the PDCP entity performs bearer data split. However, the split may be performed at a stage before PDCP (upper layer than PDCP) or after PDCP (lower layer than PDCP).

### Example 1-1

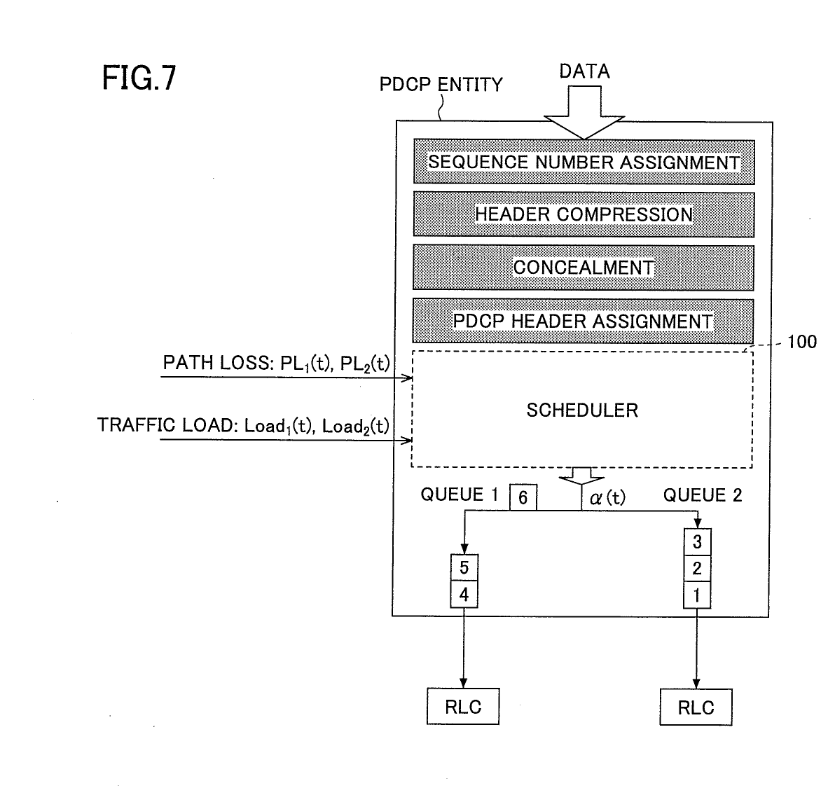

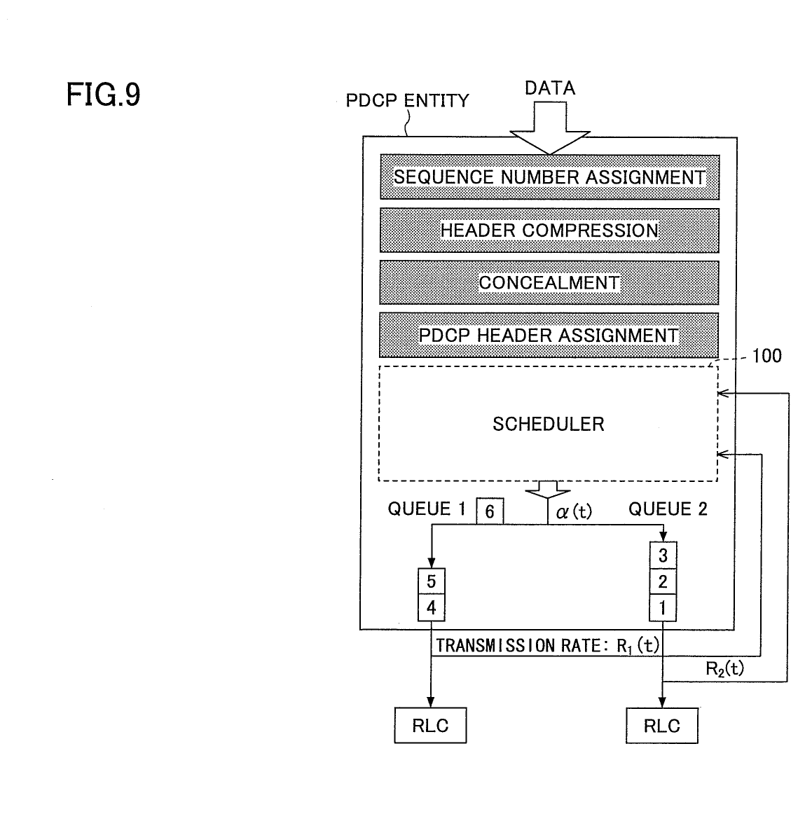

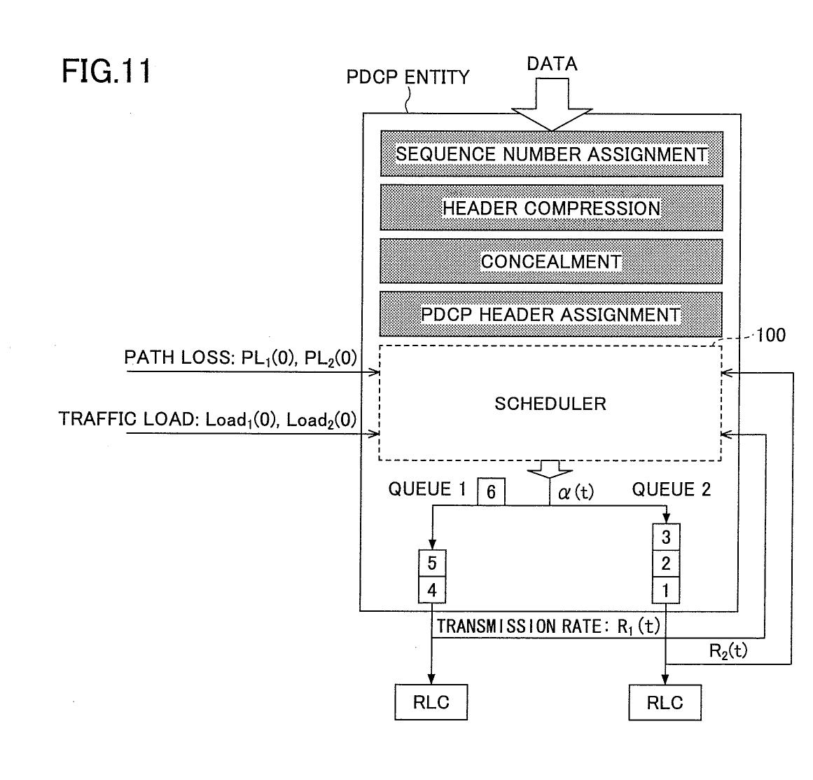

Referring to FIG. 7, process contents of the example 1-1 will be described. FIG. 7 is a drawing mainly illustrating a PDCP entity which performs a process related to the example 1-1 in the user apparatus UE. Functions of assigning a sequence number, compressing a header, concealment, and PDCP header assignment are existing functions in the PDCP entity. A scheduler 100 illustrated in FIG. 7 performs ratio determination and data division. In other words, in an example of FIG. 7, the scheduler 100 includes the ratio calculation unit 101 and the data dividing unit 102 illustrated in FIG. 6. The above point is the same in FIG. 9 and FIG. 11.

As illustrated in FIG. 7, the scheduler 100 receives path loss PL₁(t) and PL₂(t), and traffic load information (hereinafter, referred to as load information) Load₁(t) and Load₂(t), calculates the ratio α based on the path loss and the load information, and performs data division. In an example of FIG. 7, it is illustrated that data 6 is allocated to a queue 1 according to ratio α(t) at time t. In an example of FIG. 7, the queue 1 corresponds to a buffer of PDCP data for the base station MeNB, and the queue 2 corresponds to a buffer of PDCP data for the base station SeNB. It should be noted that, in an embodiment, a buffer for storing divided data may be a buffer of any layer.

The path loss PL₁(t) is a path loss between the base station MeNB and the user apparatus UE at time t, and the PL₂(t) is a path loss between the base station SeNB and the user apparatus UE at time t. The path losses may be calculated (estimated) by the user apparatus UE based on a signal, etc., received from the base stations (MeNB, SeNB), or may be calculated (estimated) by the base stations (MeNB, SeNB), and transmitted to the user apparatus UE to be used by the user apparatus UE. It should be noted that the path loss is an example of radio quality. Information other than the path loss may be obtained as radio quality, and used for calculation of the ratio α. The above will be applied to other examples in which the path loss is used. As radio quality information other than the path loss used for calculation of the ratio α, CQI, RSRP, RSRQ, etc., can be listed.

The load information Load₁(t) is the load information of the base station MeNB, and the Load₂(t) is the load information of the base station SeNB. The Load₁ (t) and Load₂ (t) may be calculated by the base stations (MeNB, SeNB) and transmitted to the user apparatus UE from the base stations (MeNB, SeNB), or may be calculated (estimated) by the user apparatus UE based on quality information (RSRQ, etc.,) of signals received from the base stations. For example, the more number of active UEs in the base stations eNB (MCG, SCG), the higher the load. A calculation method of load information at the base stations is not limited to a specific method. For example, a method described in a second embodiment can be used.

The ratio α(t) at time t is calculated based on PL₁ (t), PL₂ (t), Load₁ (t), and Load₂ (t). Therefore, α(t) can be expressed by α(t)=f(PL₁ (t), PL₂ (t). Load₁ (t), Load₂ (t)). An example of a calculation formula for calculating a is as follows.

$$\begin{matrix}( FORMULA 1 ) & \\ \begin{matrix}α ( t ) = f ( {PL}_{1} ( t ) , {PL}_{2} ( t ) , {Load}_{1} ( t ) , {Load}_{2} ( t ) ) \\ = \frac{\frac{{ER}_{1} ( t )}{{Load}_{1} ( t )}}{\frac{{ER}_{1} ( t )}{{Load}_{1} ( t )} + \frac{{ER}_{2} ( t )}{{Load}_{2} ( t )}} \\ = \frac{1}{1 + {log}_{2} ( \frac{{k}_{2}}{{PL}_{2} ( t )} - \frac{{k}_{1}}{{PL}_{1} ( t )} ) \times \frac{{Load}_{1} ( t )}{{Load}_{2} ( t )}}\end{matrix} & [ Math 1 ]\end{matrix}$$

In the above formula,

$$\frac{1}{{Load}_{i} ( t )} , i = 1 , 2 \qquad [ Math 2 ]$$

are scheduling factors. Further, ER is an estimated rate, and is calculated by the following formula.

$${ER}_{i} ( t ) = {log}_{2} ( 1 + \frac{{k}_{i}}{{PL}_{i} ( t )} ) \qquad [ Math 3 ]$$

In the above formula, kᵢ is a compensating factor (predetermined coefficient).

As illustrated in formula 1, the ratio for the base station becomes greater as the load of the base station is lower and the path loss of the base station is smaller. It should be noted that calculating the ratio by using formula 1 is merely an example. The ratio may be calculated by another method by using radio quality and load information.

As described above, the user apparatus UE may receive the load information from the base stations (MeNB, SeNB), or the user apparatus UE may estimate the load information. In the case where the user apparatus UE receives the load information from the base stations (MeNB, SeNB), Load₁ (t) may be received from the base station MeNB and Load₂ (t) may be received from the base station SeNB, or the base station MeNB may receive Load₂ (t) from the base station SeNB and the base station MeNB may transmit Load₁ (t) and Load₂ (t) to the user apparatus UE. Further, load information transmission from the base stations (MeNB, SeNB) to the user apparatus UE may be performed by using an RRC signal, a MAC signal, or a signal other than the RRC signal and the MAC signal.

Further, the base station MeNB may transmit the load information triggered by addition of SeNB (SCG). In the case where SCG is added, the base station MeNB transmits an RRC signal to the user apparatus UE, which RRC signal may be used for transmitting the load information.

Further, the base stations may transmit the load information to the user apparatus UE triggered by a change in the load of the base station MeNB or the base station SeNB, which change is equal to or greater than a predetermined threshold value. For example, assuming that the predetermined threshold value in the base station MeNB is 3, if a load value of the base station MeNB at time T1 is 10 and the load value becomes 13 at time T2, then the base station MeNB transmits Load₁(t) to the user apparatus UE at time T2 because the load value has changed by equal to or greater than the threshold value. Both Load₁(t) and Load₂(t) may be transmitted with the above trigger.

Regarding the predetermined threshold value, different threshold values such as a threshold value 1 for the base station MeNB and a threshold value 2 for the base station SeNB may be set, or a common threshold value may be used.

It should be noted that if the load information changes dynamically, then the base station has to transmit the load information frequently, and thus, communications overhead will be large. Therefore, by having a prohibit timer, the load information may be transmitted only in the case where the prohibit timer is not running. It is assumed that the prohibit time starts when the load information is transmitted. The prohibit timer value may be common between the base stations, or different timer values may be individually set for the base stations.

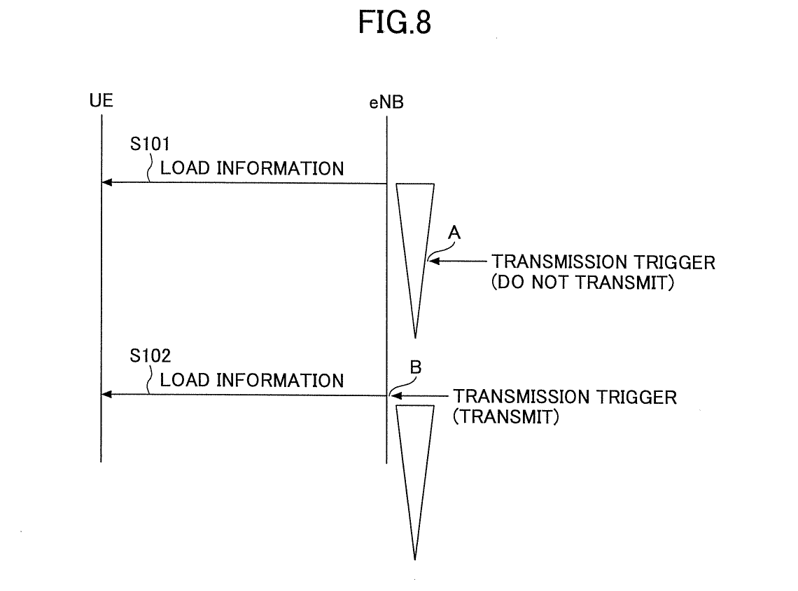

Referring to FIG. 8, an operation example of the prohibit timer will be described. A trigger for load information transmission occurs at the base station eNB (MeNB or SeNB), and the load information is transmitted to the user apparatus UE (step S101). At this time, the prohibit timer is started. Another trigger for load information transmission occurs at time A when the prohibit timer is running. The load information is not transmitted because the prohibit timer is running.

In the case where another trigger occurs at time B after the prohibit timer expires, the load information is transmitted because the prohibit timer expired (step S102). Further, the prohibit timer is started again at this time.

### Example 1-2

Next, referring to FIG. 9, an example 1-2 will be described. As illustrated in FIG. 9, in the example 1-2, the user apparatus UE measures (obtains) a UL transmission rate for the base station MeNB (MCG) R₁ (t) and a UL transmission rate for the base station SeNB (SCG) R₂ (t), and the scheduler 100 calculates the ratio α(t) by using R₁ (t) and R₂ (t).

Here, it is assumed, for example, that α(0)=1/2 at a data transmission start timing (t=0), and α(t) is calculated assuming that α(t)=f(R₁(t), R₂(t) as time t elapses.

In an example of FIG. 9, transmission rate of PDCP data (UL PDCP PDU) is used for calculating the ratio α. However, the UL transmission rate used for the ratio α calculation may be a transmission rate other than the transmission rate of the PDCP data. For example, the UL transmission rate may be a UL MAC PDU transmission rate, a UL RLC PDU transmission rate, or a transmission rate of other data. Further, MAC CE, RLC control PDU, PDCP control PDU, MAC retransmission, and RLC retransmission may not be included in the rate calculation target.

Transmission rate measurement (calculation) is performed, for example, periodically. However, it should be noted that transmission rate measurement may not be performed at a timing when there is no UL transmission. In other words, when there is no UL transmission, the value of R may not be updated.

Further, the transmission rate may be measured by the user apparatus UE, or the base stations (MeNB, SeNB) may measure UL data receive rate (corresponding to the transmission rate in terms of the user apparatus), and transmit the measured value to the user apparatus UE. Regarding the calculation method of the receive rate at the base stations, a method described in a second embodiment can be used.

An example of the ratio α calculation formula in an example 1-2 is as follows.

$$\begin{matrix} ( FORMULA 2 ) & \\ α ( t ) = \frac{[ {B}_{2} ( t - Δ t ) - {B}_{1} ( t - Δ t ) ] + [ {R}_{1} ( t ) - {R}_{2} ( t ) ] \times Δ t}{2 \times D ( t )} + \frac{1}{2} & [ Math 4 ]\end{matrix}$$

In the above formula 2, B₁(0)=B₂(0)=0, R₁(0)=R₂(0)=0. B₁(t) is amount of data remaining in a buffer j at time t. D(t) is amount of flowing-in data at time t. Rj(t) is a UL transmission rate of the buffer j at time t. Δt is a control period (e.g., BSR report period). Here, a buffer 1 is a buffer which stores data for the base station MeNB, and a buffer 2 is a buffer which stores data for the base station SeNB. The above formula 2 can be derived as follows.

The amount of data B₁(t) which remains in the buffer 1 at time t is a value calculated by adding the amount of data which has flowed into the buffer from (t−Δt) to t(α(t)×D(t)) to the amount of data remaining in the buffer at time (t−Δt) (B₁(t−Δt)), and subtracting the amount of data transmitted during the time (R₁(t)×Δt(amount of data read from the buffer)). Therefore, B₁(t) can be calculated as follows.

B₁(t)=B₁(t−Δt)+α(t)ΔD(t)−R₁(t)×Δt

Similarly, B₂(t) can be calculated as follows.

B₂(t)=B₂(t−Δt)+[1−α(t)]×D(t)−R₂(t)×Δt

Further, in this example, by setting B₁(t)=B₂(t) as a target, formula 2 for calculating Δ(t) as shown above is obtained. It should be noted that setting B₁(t)=B₂(t) as a target is an example. Further, regarding the above formulas, a forgetting coefficient may be taken into account.

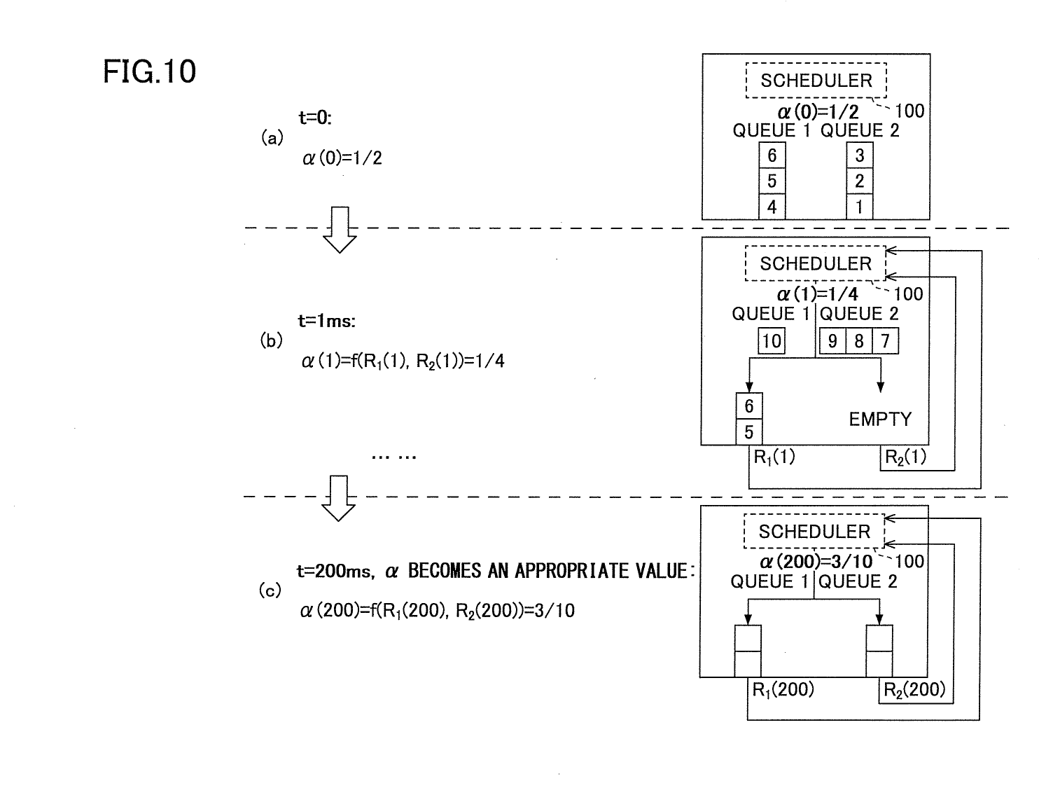

Next, referring to FIG. 10, an example of a change of α in accordance with elapsed time in the example 1-2 will be described. It should be noted that the queues in FIG. 10 are the same as buffers.

As illustrated in FIG. 10 (a), at time t=0, the initial value Δ(0)=1/2, and the same amount of data is stored in the queue 1 and the queue 2.

As illustrated in FIG. 10 (b), at time t=1 ms, α(1)=f(R₁(1), R₂(1))=1/4. At this point, the queue 2 is empty. Because α(1)=1/4, one out of four data items which have occurred at this point is stored in the queue 1, and three out of the four data items are stored in the queue 2. After passing through a state transition described above, as illustrated in FIG. 10 (c), for example at time t=200 ms, a becomes an appropriate value.

### Example 1-3>

Next, an example 1-3 will be described. The example 1-3 is a method in which the example 1-1 (open loop method) and the example 1-2 (closed loop method) are combined. In other words, as illustrated in FIG. 11, in the example 1-3, the scheduler 100 calculates the ratio α from the path loss (PL₁(0), PL₂(0)), the load information (Load₁(0), Load₂(0)), and the UL transmission rate (R₁(t), R₂(t)). A method of obtaining the path loss, the load information, and the UL transmission rate has already been described.

In this example, when calculating the ratio a at time 0, the path loss and the load information are used as in α(0)=f(PL₁(0), PL₂(0), Load₁(0), Load₂(0)), and when calculating the ratio α after time 0, the UL transmission rate is used as in α(t)=f(α(t−1), R₁(t), R₂(t)). It should be noted that the above calculation method of α is merely an example.

In the example 1-3, α(0) is calculated by the following formula.

$$\begin{matrix}( FORMULA 3 ) & \\ \begin{matrix}α ( 0 ) = \frac{\frac{{ER}_{1} ( 0 )}{{Load}_{1} ( 0 )}}{\frac{{ER}_{1} ( 0 )}{{Load}_{1} ( 0 )} + \frac{{ER}_{2} ( 0 )}{{Load}_{2} ( 0 )}} \\ = \frac{1}{1 + {log}_{2} ( \frac{{k}_{2}}{{PL}_{2} ( 0 )} - \frac{{k}_{1}}{{PL}_{1} ( 0 )} ) \times \frac{{Load}_{1} ( 0 )}{{Load}_{2} ( 0 )}}\end{matrix} & [ Math 5 ]\end{matrix}$$

The above formula 3 is a calculation formula in the example 1-1 in which t=0. Further, α(t) is calculated by the following formula.

$$\begin{matrix}( FORMULA 4 ) & \\ α ( t ) = \{ \begin{matrix}α ( t - 1 ) + p \times \frac{{R}_{1} ( t )}{{R}_{1} ( t ) + {R}_{2} ( t )} , & {R}_{1} ( t ) \geq {R}_{2} ( t ) \\ α ( t - 1 ) - q \times \frac{{R}_{1} ( t )}{{R}_{1} ( t ) + {R}_{2} ( t )} , & {R}_{1} ( t ) < {R}_{2} ( t )\end{matrix} & [ Math 6 ]\end{matrix}$$

In the above formula 4, p and q are forgetting coefficients. In the above formula, a will be increased when R₁(t) is equal to or greater than R₂(t). In other words, the ratio of the amount of data divided for the base station MeNB is increased. When R₁(t) is less than R₂(t), α will be decreased. In other words, when R₁(t) is less than R₂(t), the ratio of the amount of data divided for the base station SeNB is increased.

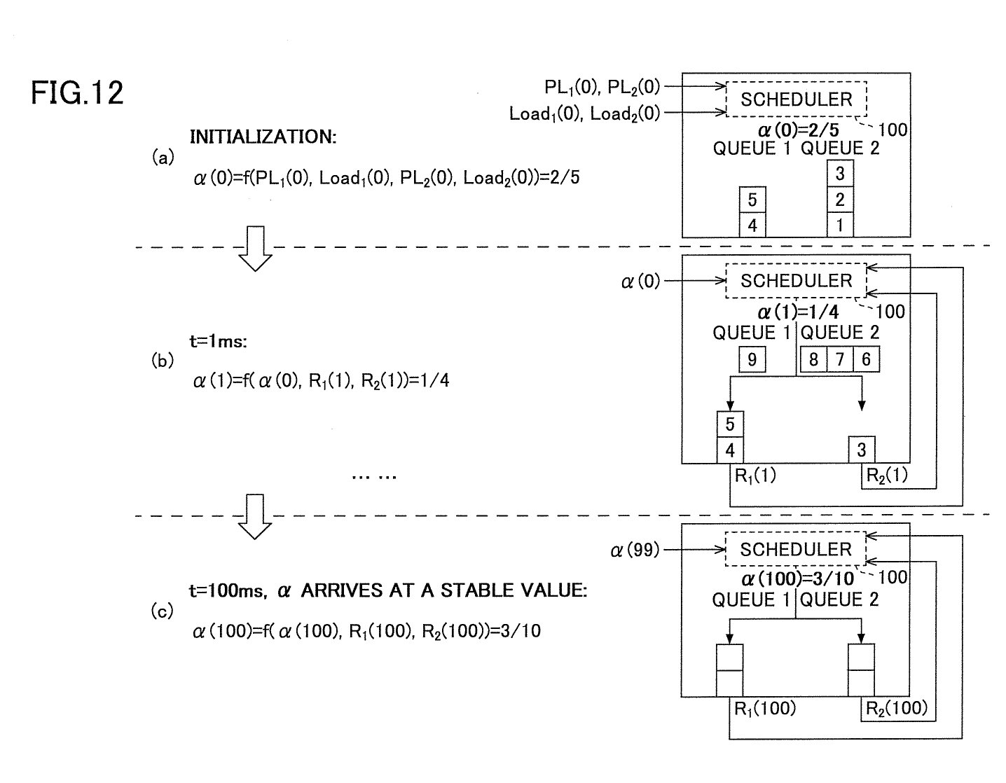

Next, referring to FIG. 12, an example of a change of α in accordance with elapsed time in the example 1-3 will be described.

As illustrated in FIG. 12 (a), at time t=0, the scheduler 100 calculates α(0) based on PL₁(0), Load₁(0), PL₂(0), and Load₂(0) by using α(0)=f(PL₁(0), Load₁(0), PL₂(0), Load₂(0))=2/5.

As illustrated in FIG. 12 (b), at time t=1 ms, α(1)=f(α(0), R₁(1), R₂(t))=1/4. After passing through a state transition described above, as illustrated in FIG. 12 (c), for example at time t=200 ms, a becomes a stable value.

### Second Embodiment

Next, a second embodiment will be described. As described above, in the second embodiment, the base station (MeNB or SeNB) calculates the ratio α, transmits the calculated ratio α to the user apparatus UE, and the user apparatus UE divides the data according to the received ratio α. The ratio α may be calculated either by the base station MeNB or by the base station SeNB. In the following, an example will be described in which the ratio α is calculated by the base station MeNB.

The method of calculating the ratio α in the second embodiment itself is the same as that in the first embodiment. The below-described example 2-1, example 2-2, and example 2-3 correspond to the example 1-1, example 1-2, and example 1-3, respectively.

### Example 2-1>

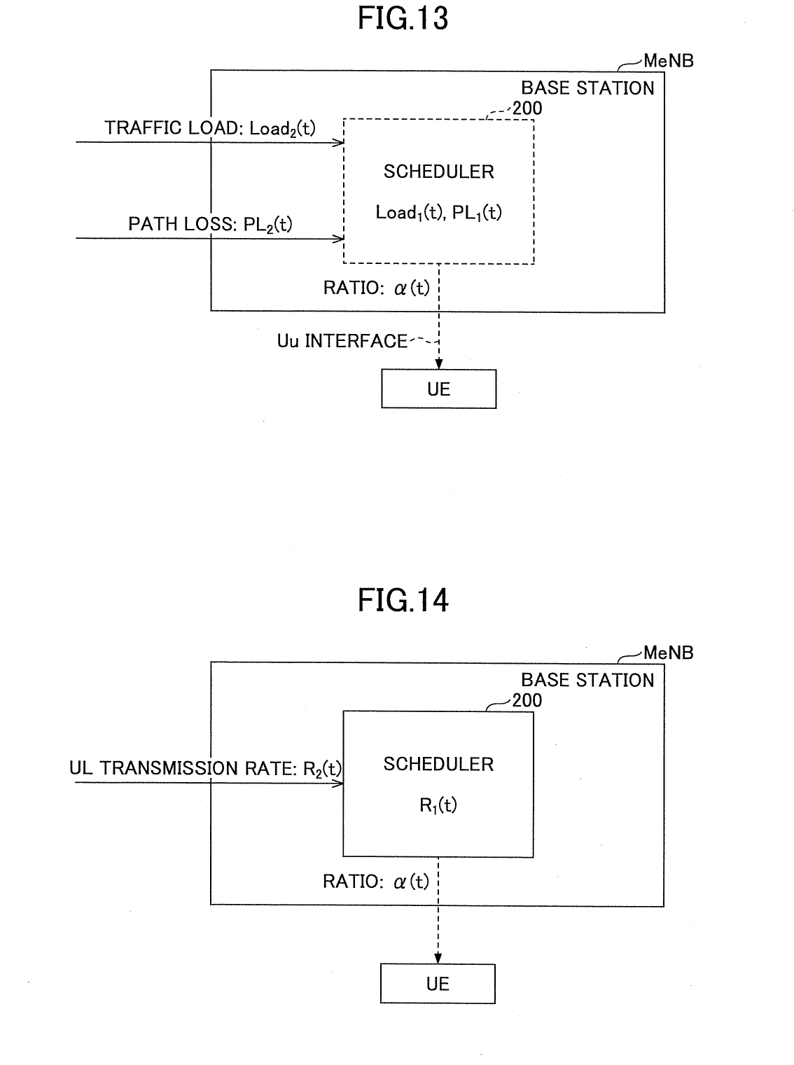

Referring to FIG. 13, process contents of the example 2-1 will be described. As illustrated in FIG. 13, the base station MeNB includes a scheduler 200 as a function unit for calculating the ratio α and transmitting the calculated ratio α to the user apparatus UE.

In the example 2-1, the base station MeNB obtains PL₁(t), PL₂(t), Load₁(t) and Load₂(t), and calculates the ratio α by using the calculation formula described in the example 1-1.

Regarding PL₁(t) and Load₁(t) of the parameters used for the ratio α calculation, the base station MeNB can use values calculated (estimated) by the base station MeNB itself. Regarding PL₂(t) and Load₂(t), for example, the base station SeNB calculates PL₂(t) and Load₂(t) and transmits PL₂(t) and Load₂(t) to the base station MeNB via X2 interface. It should be noted that information transmitted via X2 interface may be PL₂(t) and Load₂(t) themselves, or may be information used for calculating PL₂(t) and Load₂(t). The information is, for example, transmission power information for calculating a path loss (e.g., PHR), the number of connected UEs for calculating load information (which will be described in detail later), etc.

The above information items are merely examples. Regarding the path loss, the base station MeNB may receive from the user apparatus UE transmission power information (e.g., PHR) related to MCG and transmission power information related to SCG, and calculate PL₁(t) and PL₂(t) by using the received transmission power information.

Further, regarding the load information, the base station MeNB may receive from the user apparatus UE quality information (e.g., RSRQ) related to MCG and quality information related to SCG, and calculate (estimate) Load₁(t) and Load₂(t) by using the received quality information.

Further, it is possible for each of the base station MeNB and the base station SeNB to calculate the load information by using one or more of the number of RRC connected UEs, the number of scheduling UEs, DRX UE ratio, individual resource use rates, a CPU use rate at the base station, a PDSCH/PUSCH/PUCCH use rate, LD buffer remaining amount.

### Example 2-2>

Referring to FIG. 14, process contents of the example 2-2 will be described. In the example 2-2, the scheduler 200 of the base station MeNB obtains R₁(t) and R₂(t), and calculates the ratio α by using the calculation formula described in the example 1-2.

Regarding R₁(t) of the parameters used for the ratio α calculation, the base station MeNB can use the value calculated (estimated) by the case station MeNB itself. Regarding R₂(t), for example, the base station SeNB calculates R₂(t) and transmits R₂(t) to the base station MeNB via X2 interface.

In the example 2-2, the base station MeNB (also the base station SeNB) calculates as the UL reception rate the UL transmission rate at the user apparatus UE. As the UL reception rate, any one of a UL MAC SDU reception rate, a UL RLC SDU reception rate, and a UL PDCP SDU reception rate may be used. Further, a rate of only a specific bearer (e.g., a bearer for which bearer split is configured) may be a calculation target.

### <Example 2-3>

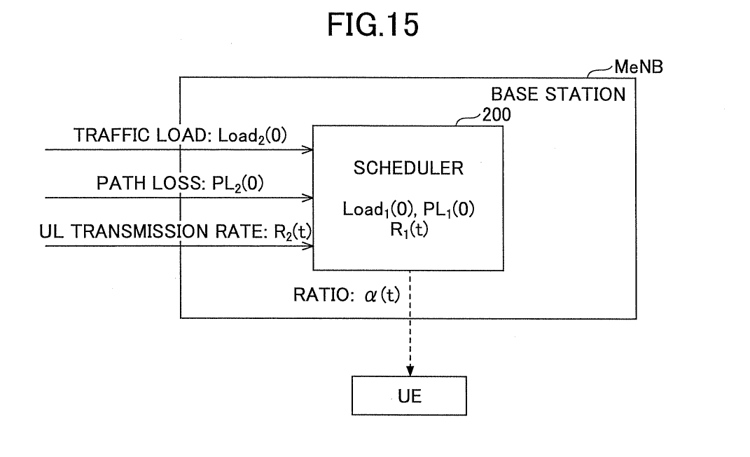

Referring to FIG. 15, process contents of the example 2-3 will be described. The example 2-3 is a method in which the example 2-1 and the example 2-2 are combined. In the example 2-3, the scheduler 200 of the base station MeNB calculates the ratio α from the path losses (PL₁(0), PL₂(0)), the load information items (Load₁(0), Load₂(0)), and the UL transmission rates (R₁(t), R₂(t)) by using the calculation formula described in the example 1-3.

### Apparatus Configuration, Flowchart

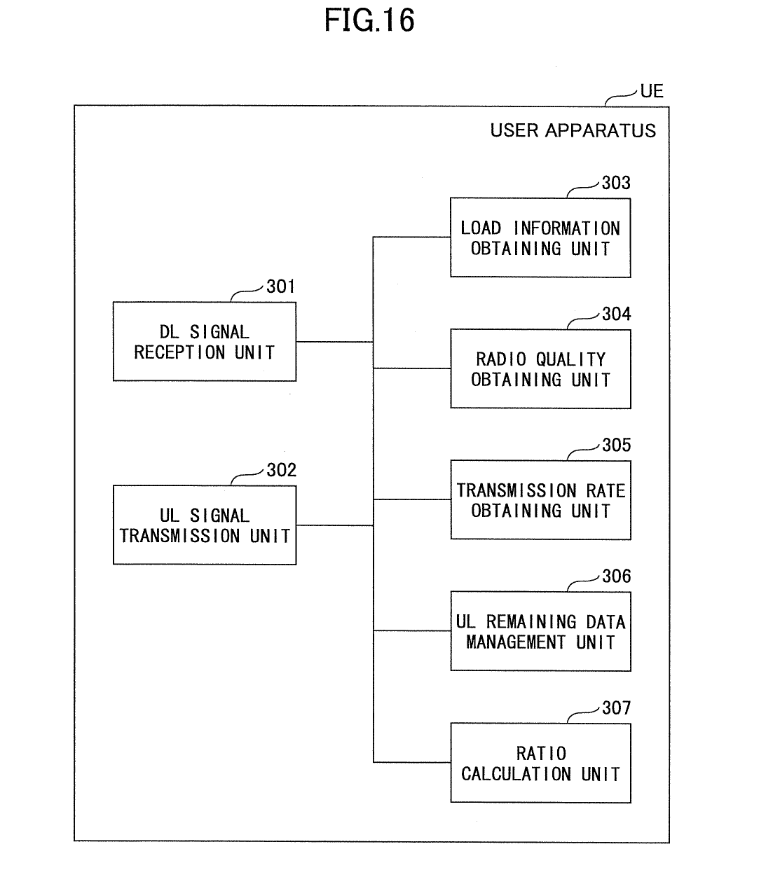

FIG. 16 illustrates a functional structure diagram of the user apparatus UE according to the first embodiment. As illustrated in FIG. 16, the user apparatus UE according to an embodiment includes a DL signal reception unit 301, a UL signal transmission unit 302, a load information obtaining unit 303, a radio quality obtaining unit 304, a transmission rate obtaining unit 305, a UL remaining data management unit 306, and a ratio calculation unit 307.

The DL signal reception unit 301 receives a radio signal from the base stations (MeNB, SeNB) and extracts information from the radio signal. The UL signal transmission unit 302 generates a radio signal from transmission information and transmits the radio signal to the base stations (MeNB, SeNB). Further, the UL signal transmission unit 302 includes a buffer 1 and a buffer 2 for UL data. The load information obtaining unit 303 obtains load information (e.g., Load₁(t), Load₂(t)) from signal measurement or from information received from the base stations, etc. The radio quality obtaining unit 304 obtains radio quality (e.g., PL₁(t), PL₂(t)) from signal measurement or from information received from the base stations, etc.

The transmission rate obtaining unit 305 obtains transmission rates (e.g., R₁(t), R₂(t)) from rate measurement of transmission data or from information received from the base stations, etc.

The UL remaining data management unit 306 includes a function for dividing the transmission data for the corresponding buffers according to the ratio α calculated by the ratio calculation unit 307. The ratio calculation unit 307 calculates the ratio α by using the methods described in the examples 1-1 through 1-3.

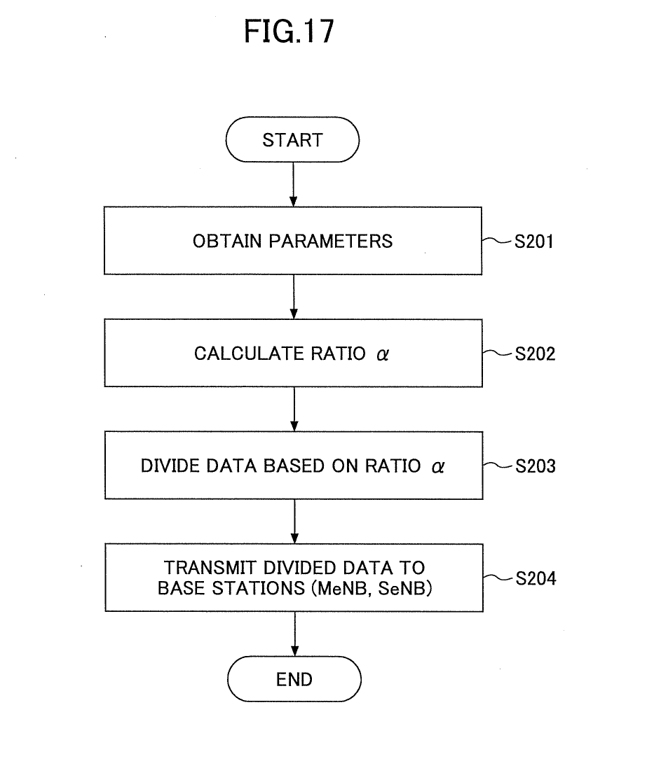

FIG. 17 illustrates a flowchart of an operation of the user apparatus UE according to the first embodiment. As described in the examples 1-1 through 1-3, the user apparatus UE obtains parameters including radio quality, load information, transmission rate, etc. (step S201). The user apparatus UE calculates the ratio α by using the parameters obtained in step S201 (step S202), and divides the uplink data of the bearer split target for the buffer 1 and the buffer 2 (step S203). Further, the user apparatus UE transmits the divided data to the base stations (MeNB, SeNB) according to, for example, resource allocation by the base stations (MeNB, SeNB) based on a buffer amount report (step S204).

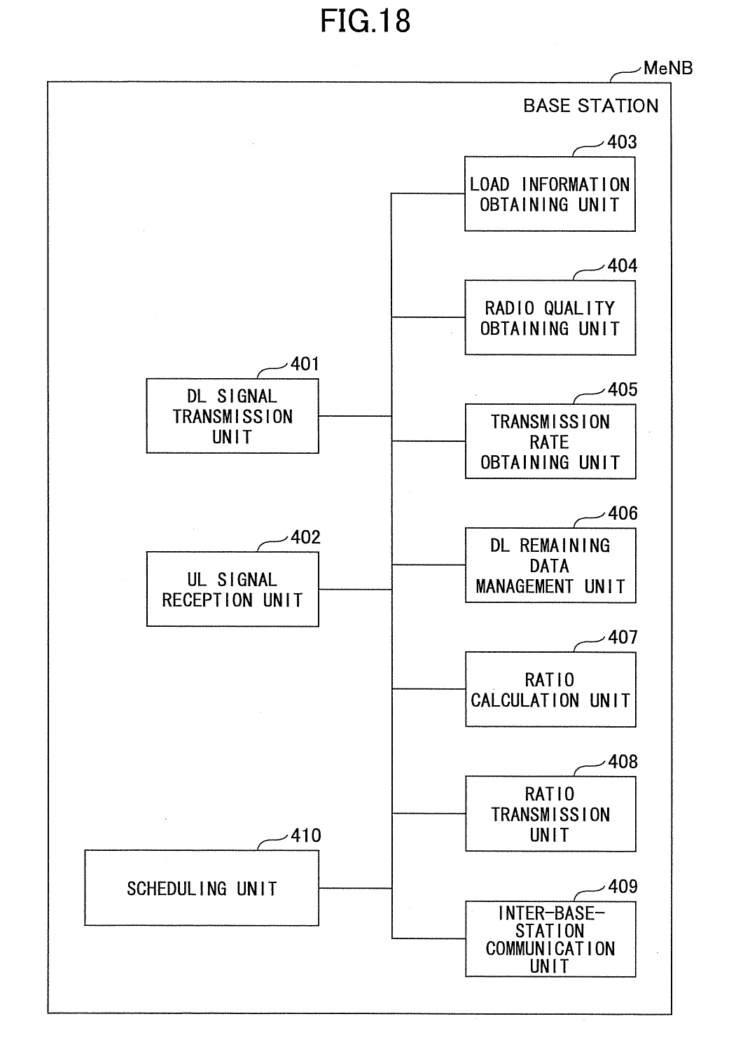

FIG. 18 illustrates a functional structure diagram of the base station MeNB according to the second embodiment. It should be noted that, in the case where the ratio α is calculated by the base station SeNB, the base station SeNB includes the same structure as illustrated in FIG. 18.

As illustrated in FIG. 18, the base station MeNB according to an embodiment includes a DL signal transmission unit 401, a UL signal reception unit 402, a load information obtaining unit 403, a radio quality obtaining unit 404, a transmission rate obtaining unit 405, a DL remaining data management unit 406, a ratio calculation unit 407, a ratio transmission unit 408, inter-base-station communication unit 409, and a scheduling unit 410.

The DL signal transmission unit 401 generates a radio signal from transmission information and transmits the radio signal to the user apparatus UE. The UL signal reception unit 402 receives a radio signal from the user apparatus UE and extracts information from the radio signal. The DL signal transmission unit 401 includes a buffer for temporarily storing data to be transmitted to the user apparatus UE.

The load information obtaining unit 403 obtains load information (e.g., Load₁(t), Load₂(t)) from signal measurement, calculation from scheduling information, etc., or information received from the base station SeNB, etc. The radio quality obtaining unit 404 obtains radio quality (e.g., PL₁(t), PL₂(t)) from signal measurement or from information received from the base stations, etc.

The transmission rate obtaining unit 405 obtains transmission rates (R₁(t), R₂(t)) from rate measurement of receive data, information received from the base stations, etc. The DL remaining data management unit 406 obtains remaining amount of a DL buffer. The remaining amount of the DL buffer can be used for load information calculation. The ratio calculation unit 407 calculates the ratio α according to the methods described in the examples 2-1 through 2-3 (that is, examples 1-1 through 1-3). The ratio transmission unit 408 performs control for transmitting the ratio α calculated by the ratio calculation unit 407 to the user apparatus UE.

The inter-base-station communication unit 409 performs data communications with the base station SeNB. The scheduling unit 410 performs scheduling including radio resource allocation for the user apparatus UE, etc. The resource allocation information, etc., obtained by the scheduling can be used for the load information calculation.

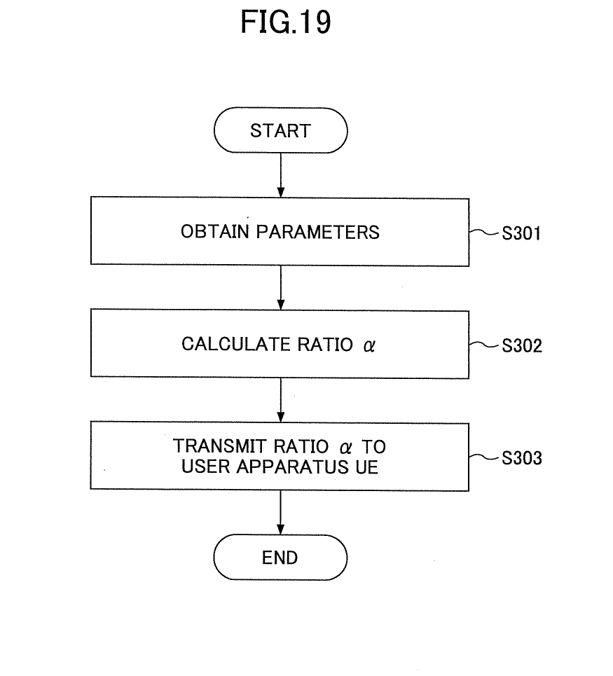

FIG. 19 illustrates a flowchart of an operation of the base station MeNB according to the second embodiment. As described in the examples 2-1 through 2-3, the base station MeNB obtains parameters including radio quality, load information, transmission rate, etc. (step S301) The base station MeNB calculates the ratio α by using the parameters obtained in step S301 (step S302), and transmits the ratio α to the user apparatus UE (step S303).

As described above, in an embodiment of the present invention, a user apparatus in a mobile communication system including a first base station and a second base station which perform communications with the user apparatus by inter-base-station carrier aggregation is provided. The user apparatus includes a radio quality obtaining unit configured to obtain first radio quality between the user apparatus and the first base station and second radio quality between the user apparatus and the second base station; a load information obtaining unit configured to obtain first load information in the first base station and second load information in the second base station; and a ratio calculation unit configured to calculate a dividing ratio used by the user apparatus for dividing uplink data and transmitting the divided data to the first base station and the second base station by using the first radio quality and the second radio quality obtained by the radio quality obtaining unit and the first load information and the second load information obtained by the load information obtaining unit.

Further, in an embodiment, a user apparatus in a mobile communication system including a first base station and a second base station which perform communications with the user apparatus by inter-base-station carrier aggregation is provided. The user apparatus includes a transmission rate obtaining unit configured to obtain a first transmission rate of data transmission from the user apparatus to the first base station and a second transmission rate of data transmission from the user apparatus to the second base station; and a ratio calculation unit configured to calculate a dividing ratio used by the user apparatus for dividing uplink data and transmitting the divided data to the first base station and the second base station by using the first and second transmission rates obtained by the transmission obtaining unit.

According to a user apparatus described above, it is possible for the user apparatus to appropriately calculate the dividing ratio which is used for dividing the uplink data and transmitting the divided data to the first base station and the second base station. As a result, it is possible to improve the UL throughput. It should be noted that, in an embodiment, the number of base stations which the user apparatus simultaneously communicates with is not limited to 2. Even when the number of the base stations is three or more, it is possible to calculate the above dividing ratio to be applied to any two of the base stations, and as a result, it is possible to calculate ratios for all of the base stations.

The above user apparatus may further include a radio quality obtaining unit configured to obtain first radio quality between the user apparatus and the first base station and second radio quality between the user apparatus and the second base station; and a load information obtaining unit configured to obtain first load information in the first base station and second load information in the second base station. The ratio calculation unit may calculate the dividing ratio by using the first quality information and the second quality information obtained by the radio quality obtaining unit; the first load information and the second load information obtained by the load information obtaining unit; and the first transmission rate and the second transmission rate obtained by the transmission rate obtaining unit. In the above arrangement, more parameters are used, and thus, the dividing ratio can be calculated more accurately.

Further, in an embodiment, a base station corresponding to a first base station in a mobile communication system including the first base station and a second base station which perform communications with a user apparatus by inter-base-station carrier aggregation is provided. The base station includes a radio quality obtaining unit configured to obtain first radio quality between the user apparatus and the first base station and second radio quality between the user apparatus and the second base station; a load information obtaining unit configured to obtain first load information in the first base station and second load information in the second base station; and a ratio calculation unit configured to calculate a dividing ratio used by the user apparatus for dividing uplink data and transmitting the divided data to the first base station and the second base station by using the first radio quality and the second radio quality obtained by the radio quality obtaining unit and the first load information and the second load information obtained by the load information obtaining unit; and a transmission unit configured to transmit the dividing ratio calculated by the ratio calculating unit to the user apparatus.

Further, in an embodiment, a base station corresponding to a first base station in a mobile communication system including the first base station and a second base station which perform communications with a user apparatus by inter-base-station carrier aggregation is provided. The base station includes a transmission rate obtaining unit configured to obtain a first transmission rate of data transmission from the user apparatus to the first base station and a second transmission rate of data transmission from the user apparatus to the second base station; a ratio calculation unit configured to calculate a dividing ratio used by the user apparatus for dividing uplink data and transmitting the divided data to the first base station and the second base station by using the first and the second transmission rates obtained by the transmission obtaining unit; and a transmission unit configured to transmit the dividing ratio calculated by the ratio calculating unit to the user apparatus.

According to a base station described above, it is possible for the base station to appropriately calculate the division ratio which is used by the user apparatus for dividing uplink data and transmitting the divided data to the first base station and the second base station.

The above base station may further include a radio quality obtaining unit configured to obtain first radio quality between the user apparatus and the first base station and second radio quality between the user apparatus and the second base station; and a load information obtaining unit configured to obtain first load information in the first base station and second load information in the second base station. The ratio calculation unit may calculate the dividing ratio by using the first quality information and the second quality information obtained by the radio quality obtaining unit; the first load information and the second load information obtained by the load information obtaining unit; and the first transmission rate and the second transmission rate obtained by the transmission rate obtaining unit. In the above arrangement, more parameters are used, and thus, the dividing ratio can be calculated more accurately.

Further, in an embodiment, an uplink data dividing ratio calculation method performed by a user apparatus in a mobile communication system including a first base station and a second base station which perform communications with the user apparatus by inter-base-station carrier aggregation is provided. The uplink data dividing ratio calculation method includes a radio quality obtaining step of obtaining first radio quality between the user apparatus and the first base station and second radio quality between the user apparatus and the second base station; a load information obtaining step of obtaining first load information in the first base station and second load information in the second base station; and a ratio calculation step of calculating a dividing ratio used by the user apparatus for dividing uplink data and transmitting the divided data to the first base station and the second base station by using the first radio quality and the second radio quality obtained by the radio quality obtaining step and the first load information and the second load information obtained by the load information obtaining step.

Further, in an embodiment, an uplink data dividing ratio calculation method performed by a user apparatus in a mobile communication system including a first base station and a second base station which perform communications with the user apparatus by inter-base-station carrier aggregation is provided. The uplink data dividing ratio calculation method includes a transmission rate obtaining step of obtaining a first transmission rate of data transmission from the user apparatus to the first base station and a second transmission rate of data transmission from the user apparatus to the second base station; and a ratio calculation step of calculating a dividing ratio used by the user apparatus for dividing uplink data and transmitting the divided data to the first base station and the second base station by using the first and the second transmission rates obtained by the transmission obtaining step.

Further, in an embodiment, an uplink data dividing ratio providing method performed by a base station corresponding to a first base station in a mobile communication system including the first base station and a second base station which perform communications with a user apparatus by inter-base-station carrier aggregation is provided. The uplink data dividing ratio providing method includes a radio quality obtaining step of obtaining first radio quality between the user apparatus and the first base station and second radio quality between the user apparatus and the second base station; a load information obtaining step of obtaining first load information in the first base station and second load information in the second base station; a ratio calculation step of calculating a dividing ratio used by the user apparatus for dividing uplink data and transmitting the divided data to the first base station and the second base station by using the first radio quality and the second radio quality obtained by the radio quality obtaining step and the first load information and the second load information obtained by the load information obtaining step; and a transmission step of transmitting the dividing ratio calculated by the ratio calculating step to the user apparatus.

Further, in an embodiment, an uplink data dividing ratio providing method performed by a base station corresponding to a first base station in a mobile communication system including the first base station and a second base station which perform communications with a user apparatus by inter-base-station carrier aggregation is provided. The uplink data dividing ratio providing method includes a transmission rate obtaining step of obtaining a first transmission rate of data transmission from the user apparatus to the first base station and a second transmission rate of data transmission from the user apparatus to the second base station; a ratio calculation step of calculating a dividing ratio used by the user apparatus for dividing uplink data and transmitting the divided data to the first base station and the second base station by using the first and the second transmission rates obtained by the transmission obtaining step; and a transmission step of transmitting the dividing ratio calculated by the ratio calculating step to the user apparatus.

According to an embodiment, it is possible for the user apparatus to appropriately calculate the division ratio which is used for dividing uplink data and transmitting the divided data to the first base station and the second base station.

The user apparatus according to an embodiment may include a CPU and a memory, may be realized by having a program executed by the CPU (processor), may be realized by hardware such as hardware circuitry in which the logic described in an embodiment is included, or may be realized by a mixture of a program and hardware.

The base station according to an embodiment may include a CPU and a memory, may be realized by having a program executed by the CPU (processor), may be realized by hardware such as hardware circuitry in which the logic described in an embodiment is included, or may be realized by a mixture of a program and hardware.

As described above, embodiments of the present invention have been described. The disclosed invention is not limited to these embodiments, and a person skilled in the art would understand various variations, modifications, replacements, or the like. Specific examples of numerical values have been used for encouraging understanding of the present invention. These numeric values are merely examples and, unless otherwise noted, any appropriate values may be used. In the above description, partitioning of items is not essential to the present invention. Matters described in more than two items may be combined if necessary. Matters described in one item may be applied to matters described in another item (as long as they do not conflict). In a functional block diagram, boundaries of functional units or processing units do not necessarily correspond to physical boundaries of parts. Operations of multiple functional units may be physically performed in a single part, or operations of a single functional unit may be physically performed by multiple parts. For the sake of description convenience, the user apparatus and the base station have been described using functional block diagrams. These apparatuses may be implemented by hardware, by software, or by combination of both. The software which is executed by a processor included in a user apparatus and the software which is executed by a processor included in a base station may be stored in a random access memory (RAM), a flash memory, a read-only memory (ROM), an EPROM, an EEPROM, a register, a hard disk drive (HDD), a removable disk, a CD-ROM, a database, a server, or any other appropriate recording medium. The present invention is not limited to the above embodiments and various variations, modifications, alternatives, replacements, etc., may be included in the present invention without departing from the spirit of the invention.

The present PCT application is based on and claims the benefit of priority of Japanese Priority Application No. 2014-086728 filed on Apr. 18, 2014, the entire contents of which are hereby incorporated by reference.

### DESCRIPTION OF THE REFERENCE NUMERALS

MeNB, SeNB base station
100, 200 scheduler
301 DL signal reception unit
302 UL signal transmission unit
303 load information obtaining unit
304 radio quality obtaining unit
305 transmission rate obtaining unit
306 UL remaining data management unit
307 ratio calculation unit
401 DL signal transmission unit
402 UL signal reception unit
403 load information obtaining unit
404 radio quality obtaining unit
405 transmission rate obtaining unit
406 DL remaining data management unit
407 ratio calculation unit
408 ratio transmission unit
409 inter-base-station communication unit
410 scheduling unit

What is claimed is:

1. A user apparatus in a mobile communication system including a first base station and a second base station which base stations communicate with the user apparatus by inter-base-station carrier aggregation, the user apparatus comprising:
a radio quality obtaining unit configured to obtain first radio quality between the user apparatus and the first base station and second radio quality between the user apparatus and the second base station;
a load information obtaining unit configured to obtain first load information in the first base station and second load information in the second base station; and
a ratio calculation unit configured to calculate, by using the first radio quality and the second radio quality obtained by the radio quality obtaining unit and the first load information and the second load information obtained by the load information obtaining unit, a dividing ratio used by the user apparatus for dividing uplink data and transmitting the divided data to the first base station and the second base station.

2. A user apparatus in a mobile communication system including a first base station and a second base station which base stations communicate with the user apparatus by inter-base-station carrier aggregation, the user apparatus comprising:
a transmission rate obtaining unit configured to obtain a first transmission rate of data transmission from the user apparatus to the first base station and a second transmission rate of data transmission from the user apparatus to the second base station; and
a ratio calculation unit configured to calculate, by using the first transmission rate and the second transmission rate obtained by the transmission rate obtaining unit, a dividing ratio used by the user apparatus for dividing uplink data and transmitting the divided data to the first base station and the second base station.

3. The user apparatus according to claim 2, the user apparatus further comprising:
a radio quality obtaining unit configured to obtain first radio quality between the user apparatus and the first base station and second radio quality between the user apparatus and the second base station; and
a load information obtaining unit configured to obtain first load information in the first base station and second load information in the second base station, wherein
the ratio calculation unit calculates the dividing ratio by using the first radio quality and the second radio quality obtained by the radio quality obtaining unit, the first load information and the second load information obtained by the load information obtaining unit, and the first transmission rate and the second transmission rate obtained by the transmission obtaining unit.

4. A base station corresponding to a first base station in a mobile communication system including the first base station and a second base station which base stations communicate with a user apparatus by inter-base-station carrier aggregation, the base station comprising:
a radio quality obtaining unit configured to obtain first radio quality between the user apparatus and the first base station and second radio quality between the user apparatus and the second base station;
a load information obtaining unit configured to obtain first load information in the first base station and second load information in the second base station;
a ratio calculation unit configured to calculate, by using the first radio quality and the second radio quality obtained by the radio quality obtaining unit and the first load information and the second load information obtained by the load information obtaining unit, a dividing ratio used by the user apparatus for dividing uplink data and transmitting the divided data to the first base station and the second base station; and
a transmission unit configured to transmit the dividing ratio calculated by the ratio calculating unit to the user apparatus.

5. A base station corresponding to a first base station in a mobile communication system including the first base station and a second base station which base stations communicate with a user apparatus by inter-base-station carrier aggregation, the base station comprising:
a transmission rate obtaining unit configured to obtain a first transmission rate of data transmission from the user apparatus to the first base station and a second transmission rate of data transmission from the user apparatus to the second base station;
a ratio calculation unit configured to calculate, by using the first transmission rate and the second transmission rate obtained by the transmission rate obtaining unit, a dividing ratio used by the user apparatus for dividing uplink data and transmitting the divided data to the first base station and the second base station; and
a transmission unit configured to transmit the dividing ratio calculated by the ratio calculating unit to the user apparatus.

6. The base station according to claim 5, the base station further comprising:
a radio quality obtaining unit configured to obtain first radio quality between the user apparatus and the first base station and second radio quality between the user apparatus and the second base station; and
a load information obtaining unit configured to obtain first load information in the first base station and second load information in the second base station, wherein
the ratio calculation unit calculates the dividing ratio by using the first radio quality and the second radio quality obtained by the radio quality obtaining unit, the first load information and the second load information obtained by the load information obtaining unit, and the first transmission rate and the second transmission rate obtained by the transmission obtaining unit.

7. An uplink data dividing ratio calculation method performed by a user apparatus in a mobile communication system including a first base station and a second base station which base stations communicate with the user apparatus by inter-base-station carrier aggregation, the uplink data dividing ratio calculation method comprising:
a radio quality obtaining step of obtaining first radio quality between the user apparatus and the first base station and second radio quality between the user apparatus and the second base station;
a load information obtaining step of obtaining first load information in the first base station and second load information in the second base station; and
a ratio calculation step of calculating, by using the first radio quality and the second radio quality obtained by the radio quality obtaining step and the first load information and the second load information obtained by the load information obtaining step, a dividing ratio used by the user apparatus for dividing uplink data and transmitting the divided data to the first base station and the second base station.

8. An uplink data dividing ratio calculation method performed by a user apparatus in a mobile communication system including a first base station and a second base station which base stations communicate with the user apparatus by inter-base-station carrier aggregation, the uplink data dividing ratio calculation method comprising:
a transmission rate obtaining step of obtaining a first transmission rate of data transmission from the user apparatus to the first base station and a second transmission rate of data transmission from the user apparatus to the second base station; and
a ratio calculation step of calculating, by using the first transmission rate and the second transmission rate obtained by the transmission rate obtaining step, a dividing ratio used by the user apparatus for dividing uplink data and transmitting the divided data to the first base station and the second base station.

9. An uplink data dividing ratio providing method performed by a base station corresponding to a first base station in a mobile communication system including the first base station and a second base station which base stations communicate with a user apparatus by inter-base-station carrier aggregation, the uplink data dividing ratio calculation method comprising:
a radio quality obtaining step of obtaining first radio quality between the user apparatus and the first base station and second radio quality between the user apparatus and the second base station;
a load information obtaining step of obtaining first load information in the first base station and second load information in the second base station;
a ratio calculation step of calculating, by using the first radio quality and the second radio quality obtained by the radio quality obtaining step and the first load information and the second load information obtained by the load information obtaining step, a dividing ratio used by the user apparatus for dividing uplink data and transmitting the divided data to the first base station and the second base station; and
a transmission step of transmitting the dividing ratio calculated by the ratio calculating unit to the user apparatus.

10. An uplink data dividing ratio providing method performed by a base station corresponding to a first base station in a mobile communication system including the first base station and a second base station which base stations communicate with a user apparatus by inter-base-station carrier aggregation, the uplink data dividing ratio calculation method comprising:
a transmission rate obtaining step of obtaining a first transmission rate of data transmission from the user apparatus to the first base station and a second transmission rate of data transmission from the user apparatus to the second base station;
a ratio calculation step of calculating, by using the first transmission rate and the second transmission rate obtained by the transmission rate obtaining step, a dividing ratio used by the user apparatus for dividing uplink data and transmitting the divided data to the first base station and the second base station; and
a transmission step of transmitting the dividing ratio calculated by the ratio calculating unit to the user apparatus.
